(19) United States
(12) Patent Application Publication
(10) Pub. No.: US 2020/0084983 A1
(43) Pub. Date: Mar. 19, 2020

(54) Automated Hydroponic Greenhouses

(71) Applicant: Aqua Design Innovations, San Diego, CA (US)

(72) Inventors: Kevin Z. Liang, San Diego, CA (US); Andrew Hung, San Diego, CA (US); Mark Huang, San Diego, CA (US)

(21) Appl. No.: 16/131,693

(22) Filed: Sep. 14, 2018

(51) Int. Cl. A01G 31/02; A01G 24/44; B01D 46/46; B01D 46/44; B01D 46/00; B01D 53/04; B01D 53/00

(52) U.S. Cl. CPC A01G 31/02; A01G 24/44; B01D 46/46; B01D 46/448; B01D 2259/4508; B01D 53/04; B01D 53/007; B01D 2253/102; B01D 2279/50; B01D 46/0026

(57) ABSTRACT

A self-contained air filtration system is disclosed herein. The system includes a processor. The processor can receive data from one or several components of the system and can provide control signals to one or several components of the system. The system can include a housing. The housing can include: a reservoir portion; and a greenhouse portion. The greenhouse portion can connect to the reservoir portion via a grow tray. A top of the reservoir portion and the greenhouse portion define an enclosed volume. The greenhouse portion can include an inlet aperture and an outlet aperture. The inlet aperture can be obstructed by an inlet filter such that air flowing into the greenhouse portion passes through the inlet filter, and the greenhouse portion can be connected to a fan that can propel air through the inlet aperture and out of the outlet aperture.

### CROSS-REFERENCES TO RELATED APPLICATIONS

This application claims the benefit of U.S. Provisional application Ser. No. ______, filed on Mar. 28, 2016 and entitled ______, the entirety of which is hereby incorporated by reference herein.

### BACKGROUND

A computer network or data network is a telecommunications network which allows computers to exchange data. In computer networks, networked computing devices exchange data with each other along network links (data connections). The connections between nodes are established using either cable media or wireless media. The best-known computer network is the Internet.

### BRIEF SUMMARY OF THE INVENTION

One aspect of the present disclosure relates to a self-contained air filtration system. The system includes a processor that can receive data from one or several components of the system and can provide control signals to one or several components of the system. The system can include a housing that can include: a reservoir portion; and a greenhouse portion connecting to the reservoir portion via a grow tray. In some embodiments, the greenhouse portion defines an enclosed volume. In some embodiments, the greenhouse portion includes an inlet aperture and an outlet aperture. In some embodiments, the inlet aperture can be obstructed by an inlet filter such that air flowing into the greenhouse portion passes through the inlet filter. In some embodiments, the greenhouse portion includes a fan that can propel air through the inlet aperture and out of the outlet aperture.

In some embodiments, the grow tray includes a sponge having a plurality of troughs arranged in a checkered pattern. In some embodiments, the processor can control the fan to affect the velocity of air passing through the enclosed volume according to at least one of: a humidity level measured in the enclosed volume; a size of a plant in the enclosed volume; a weight of the plant in the enclosed volume; or a temperature level measured in the enclosed volume.

In some embodiments the reservoir portion includes a pump fluidly connected to the grow tray such that pump can deliver water to the grow tray. In some embodiments the reservoir portion includes a humidifying element configured humidify the air in the greenhouse portion. In some embodiments, the humidifying element includes a droplet generator.

In some embodiments, the grow tray includes a plurality of apertures extending through the grow tray and fluidly connecting the reservoir portion to the greenhouse portion such that droplets generated by the droplet generator can enter the greenhouse portion. In some embodiments, the reservoir portion includes a drain and a water level sensor. In some embodiments, the reservoir portion includes a turbidity sensor that can measure the turbidity of water stored in the reservoir portion of the housing.

In some embodiments, the greenhouse portion includes a plurality of sensors. In some embodiments, the plurality of sensors can include at least one of: a light sensor; a humidity sensor; a moisture sensor; an oxygen sensor; a carbon dioxide sensor; or a plant size sensor. In some embodiments, the plurality of sensors include: a light sensor, a humidity sensor positioned to measure the relative humidity of the air in the greenhouse portion; a moisture sensor positioned to measure a moisture level in the grow tray; and a plant size sensor. In some embodiments, the plant size sensor includes a scale. In some embodiments, the plant size sensor includes an optical detection system.

In some embodiments, the greenhouse portion includes an outlet filter obstructing the outlet such that air flowing out of the greenhouse portion passes through the outlet filter. In some embodiments, each of the inlet filter and the outlet filter include a first component and a second component. In some embodiments, the first component includes an activated carbon filter element. In some embodiments, the second element includes a HEPA filter element. In some embodiments, the greenhouse portion includes a UV illuminator positioned to illuminate at least one of the first portion and the second portion of the outlet filter.

In some embodiments, the greenhouse portion includes a plurality of walls extending between a top and a bottom of the greenhouse portion. In some embodiments, the distance between the top and the bottom of the greenhouse portion is at least one of: a constant distance or a variable distance. In some embodiments, the plurality of walls partially define the enclosed volume. In some embodiments, the some or all of the plurality of walls are at least one of: transparent; opaque; or reflective.

In some embodiments, the processor is communicatingly connected to the plurality of sensors. In some embodiments, the greenhouse portion includes a first illumination feature located at the top of the greenhouse portion and a second illumination feature extending at least partially between the top and the bottom of the greenhouse portion. In some embodiments, the second illumination feature includes a plurality of illumination elements located at different positions between the top and the bottom of the greenhouse portion. In some embodiments, the first and second illumination features are controllably connected by the processor. In some embodiments, the processor can selectively power some or all of the illumination elements in the second illumination feature based on a detected size of a plant in the enclosed volume of the greenhouse portion.

### BRIEF DESCRIPTION OF THE DRAWINGS

FIG. 1 is a perspective view of one embodiment of self-contained air filtration system.

FIG. 2 is a perspective view of one embodiment of a grow tray.

FIG. 3 is an exploded view of one embodiment of the self-contained air filtration system.

FIG. 4 is a schematic view of one embodiment of a layout of the first illumination feature.

FIG. 5 is a perspective view of one embodiment of the second illumination feature.

FIG. 6 is a depiction of one embodiment of a filtration member.

FIG. 7 is a perspective view of one embodiment of a reservoir portion.

FIG. 8 is a top view of one embodiment of the reservoir portion.

FIG. 9 is a side view of one embodiment of the drain spout.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

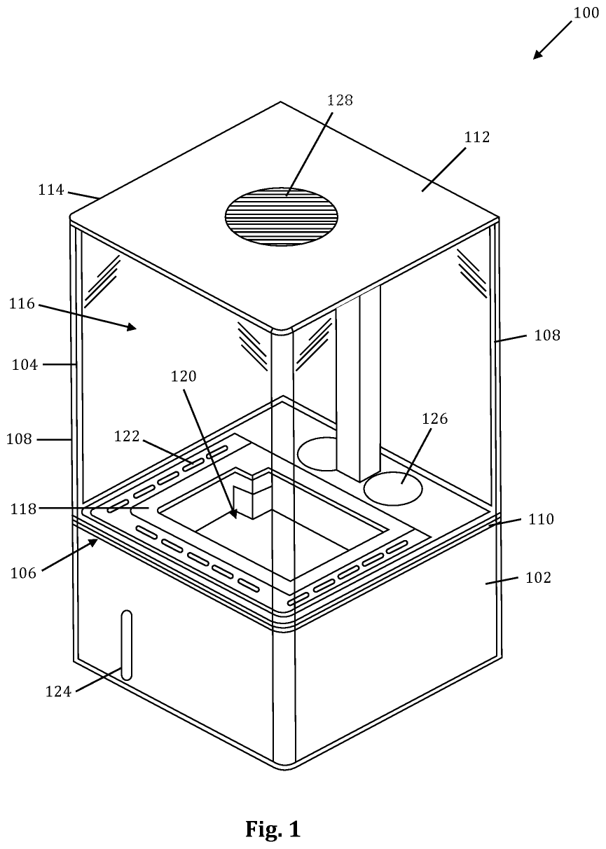

With reference now to FIG. 1, a perspective view of one embodiment of a self-contained air filtration system 100 is shown. In some embodiments, the self-container air filtration system 100 can include a reservoir portion 102 and a greenhouse portion 104 that can removably sit on a top 106 of the reservoir portion 102.

The greenhouse portion 104 can comprise a plurality of walls 108 that can extend from a bottom 110 of the greenhouse portion 104 to a top 112 of the greenhouse portion 104. In some embodiments, these walls 108 can comprise a fixed size, and in some embodiments, these walls can comprise a variable size. Specifically, in some embodiments, the distance between the top 112 and the bottom 110 of the greenhouse portion 104 can vary based on a detected size of the plant growing in the enclosed volume 116. In some embodiments, one or several of the plurality of walls can be translucent, opaque, and/or reflective.

In some embodiments, the top 112 of the greenhouse portion 104 can comprise roof 114, and in some embodiments, the bottom 110 of the greenhouse portion 104 can be open. The plurality of walls 108, the top 112, and the bottom 110 of the greenhouse portion 104 can together define an enclosed volume 116 that can be sized and shaped to receive and grow a plant. In some embodiments, the greenhouse portion 104 can comprise a plurality of sensors configured to detect one or several attributes of the greenhouse portion 104, the enclosed volume 116, and/or of the plant growing in the enclosed volume 116. In some embodiments, these sensors can include at least one of: a light sensor; a humidity sensor; a moisture sensor; an oxygen sensor; a carbon dioxide sensor; and/or a plant size sensor. In some embodiments, these sensors can include: a light sensor, a humidity sensor positioned to measure the relative humidity of the air in the greenhouse portion; a moisture sensor positioned to measure a moisture level in the grow tray; and/or a plant size sensor. In some embodiments, the plant size sensor can comprise a scale, and in some embodiments, the plant size sensor can comprise an optical sensor.

The self-container air filtration system 100 can further include a grow tray 118 that can be received within the reservoir portion 102. The grow tray 118 can comprise a variety of shapes and sizes and can be made from a variety of materials. In some embodiments, the grow tray can comprise a polymer, a foam, or the like. In some embodiments, the grow tray 118 can comprise a water permeable material. In some embodiments, the grow tray 118 can comprise a water inlet and a water outlet. In some embodiments, the water inlet can be connected to a water delivery device and the water outlet can be connected to the reservoir of the reservoir portion such that any excess water can return to the reservoir.

In some embodiments, the grow tray 118 can be associated with one or several sensors. In some embodiments, these sensors can include, for example, a moisture sensor configured to determine a moisture level in the grow tray 118, a scale configured to determine the weight of the plant growing from the grow tray, or the like.

In some embodiments, the grow tray 118, when received within the reservoir portion 102 can be sloped and/or angled such that a liquid provided to a top of the sloped portion will run towards and to the bottom of the sloped portion. Specifically, in some embodiments, the grow tray 118 can be sloped from the water inlet to the water outlet such that water delivered to the grow tray 118 at the water inlet will travel to or towards the water outlet where the water will drain from the grow tray 118. In some embodiments, this slope can be between approximately 0 and 5 degrees. As used anywhere herein, “approximately” refers to a range of +/−10% of the value and/or range of values for which “approximately” is used.

In some embodiments, the grow tray 118 can comprise one or several portions for receiving and/or containing seeds and/or root media. In some embodiments, these one or several portions can comprise one or several troughs 120. In some embodiments, the root media can comprise a granular material such as sand, gravel, pebbles, clay balls, beads, glass beads, or the like.

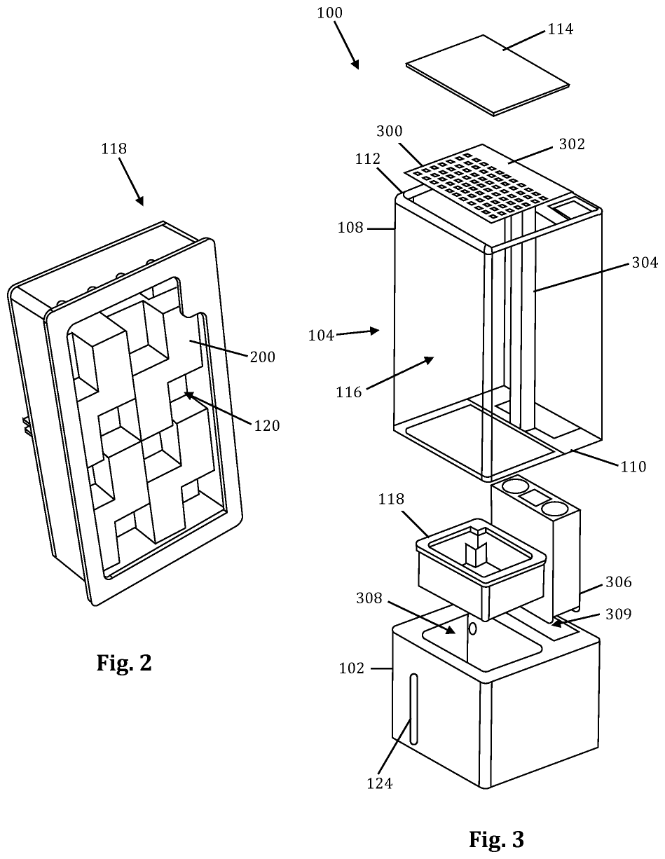

One embodiment of the grow tray 118 is depicted in FIG. 2. In this embodiment, the grow tray 118 comprises a sponge having a plurality of troughs 120 arranged in a checkered pattern. In the embodiment depicted in FIG. 2, a plurality of ridges and/or pedestals 200 are interspersed between the troughs 120. In some embodiments,

In embodiments in which the greenhouse portion 104 is on top of the reservoir portion 102, the top 106 of the reservoir portion 102 and the grow tray 118 can be proximate to the bottom 110 of the greenhouse portion 104. In some embodiments, the top 106 of the reservoir portion 102 and the grow tray 118 can sealingly mate with the portions of the plurality of walls 108 proximate to the bottom 110 of the greenhouse portion 104 to thereby seal the enclosed volume.

In some embodiments, the reservoir portion 102 can include a plurality of apertures 122 located in portions of the top 106 of the reservoir portion 102. In some embodiments, these apertures can fluidly or pneumatically connect a reservoir of the reservoir portion 102 with the enclosed volume 116 of the greenhouse portion with the top 106 of the reservoir portion 102 and the grow tray 118 seal the enclosed volume 116. In some embodiments, the apertures 122 can allow fog or mist to rise from the reservoir of the reservoir portion 102 into the enclosed volume 116.

The reservoir portion 102 can further include a water level indicator 124 that can be, for example, associated with a water level sensor. In some embodiments, the water level indicator 124 can provide an indicator of the level of the water inside of the reservoir of the reservoir portion 102. In some embodiments, the indicator can comprise a visual indicator such as, for example, one or several Light Emitting Diodes (LED) that can change illumination and/or color based on the water level in the reservoir.

In some embodiments, the reservoir portion 102 can further include one or several sensors configured to detect and/or monitor an attribute of the water in the reservoir portion 102. In some embodiments, this can include, for example, a turbidity sensor configured to measure the turbidity of the water in the reservoir portion 102.

The self-contained air filtration system 100 can further include an inlet aperture 126 and an outlet aperture 128. In some embodiments, the inlet aperture 126 can be configured to allow air to enter into the enclosed volume 116 and in some embodiments, the outlet aperture 128 can be configured to allow air to exit the enclosed volume 116. The inlet aperture 126 and the outlet aperture 128 can comprise a variety of shapes and sizes and can be placed in a variety of locations. In the embodiment depicted in FIG. 1, the inlet aperture 126 is located in the top 106 of the reservoir portion 102 and the outlet aperture 128 is located in the roof 114 at the top 112 of the greenhouse portion 104.

One or both of the inlet aperture 126 and the outlet aperture 128 can be associated with one or several air treatment elements, components, or systems. In some embodiments this can include, for example, one or several fans, filters, filter elements, illumination devices, or the like. In some embodiments, the one or several air treatment elements, components, or systems associated with one or both of the inlet aperture 126 and the outlet aperture 128 can include one or several UV illuminators. In some embodiments, for example, the treatment elements, components, or systems associated with the outlet aperture 128 can comprise a UV illuminator configured to sterilize the treatment elements, components, or systems.

The self-contained air filtration system 100 can further include a vertical strut 130. In some embodiments, the vertical strut 130 can comprise an elongate member extending from the bottom 110 of the greenhouse portion 104 to the top 112 of the greenhouse portion 104. The vertical strut 130 can comprise a variety of shapes and sizes. In some embodiments, the vertical strut 130 can comprise a member having a wholly or partially defined internal volume that can contain one or several wires configured for powering components such as one or several lights, fans, LEDs, sensors, or the like in the greenhouse portion 104. In some embodiments, the vertical strut 130 can be further configured to connect with lighting components 300 to provide support for one or several lighting components 300. In some embodiments, for example, one or both of the first illumination feature 302 and the second illumination feature 304 can connect to and/or be mounted on the vertical strut 130.

In some embodiments, the vertical strut 130 can be configured to electrically connect with the reservoir portion 102 to thereby provide power from the reservoir portion 102 and the therein contained power module 712 to the greenhouse portion 104. In some embodiments, for example, this connection can be achieved via one or several electrical connectors, and specifically by four electrical connectors that can be located in the vertical strut 130 and that can mate with four mating connectors located in the reservoir portion 102. In some embodiments, these one or several electrical connectors can be spring loaded.

With reference now to FIG. 3, an exploded view of one embodiment of the self-contained air filtration system 100 is shown. FIG. 3 depicts the reservoir portion 102, the greenhouse portion 104, and the grow tray 118. As seen in FIG. 3, the greenhouse portion 104 includes the plurality of walls 108, the roof 114, also referred to herein as the cover 114, and lighting components 300. In some embodiments, the lighting components 300 can comprise a variety of shapes and sizes and be placed in a variety of locations in and/or around the greenhouse portion 104. In some embodiments, the lighting components 300 can be controlled to selectively illuminate all or portions of the enclosed volume 116 and/or the plant growing within the enclosed volume 116.

In some embodiments, the lighting components 300 can comprise a first illumination feature 302 located at the top 112 of the greenhouse portion 104 and a second illumination feature 304 extending at least partially between the top 112 and the bottom 110 of the greenhouse portion 104. In some embodiments, each of the first and second illumination features 302, 304 can comprise a plurality of illumination elements 305, which illumination elements 305 can generate electromagnetic radiation in response to receipt of a current. In some embodiments, these illumination elements 305 can comprise one or several lights, light bulbs, LEDs, or the like.

The illumination elements 305 can comprise a single type of illumination element, and in some embodiments, the illumination elements 305 can comprise a plurality of types of illumination elements 305. In some embodiments, some or all of the types of illumination elements 305 can generate different wavelengths of electromagnetic radiation, generate different powers of electromagnetic radiation, or the like.

In some embodiments, the illumination elements 305 can be located at different positions on one or both of the first and second illumination features 302, 304. In one embodiment, for example, the illumination elements 305 of the second illumination feature 304 can be located at different positions between the top 112 and the bottom 110 of the greenhouse portion 104. In some embodiments, a processor in the system 100 can control some or all of the illumination elements 305 and/or the first and second illumination features 302, 304 to achieve a desired illumination. In some embodiments this can include providing illumination with one or several desired wavelengths, ratio of wavelengths, or the like. In some embodiments, providing a desired illumination can include selectively powering illumination elements 305 based on a detected size of the plant in the enclosed volume 116. In some embodiments, this can include the processor determining the size of the plant in the enclosed volume 116, the processor selecting the illumination elements 305 of, for example, the second illumination feature 304 corresponding to the detected size of the plant in the enclosed volume 116, and the processor powering the selected illumination elements 305. Thus, in some embodiments, as the plant grows, the illumination elements 305 in the second illumination feature 304 can be controlled by the processor such that a taller plant is illuminated by more illumination elements 305 in the second illumination feature 304 and that the illumination elements 305 used to illuminate the plant in the enclosed volume are selected as having a position between the top 112 and the bottom 110 of the greenhouse portion 104 corresponding to the detected size of the plant growing in the enclosed volume 116.

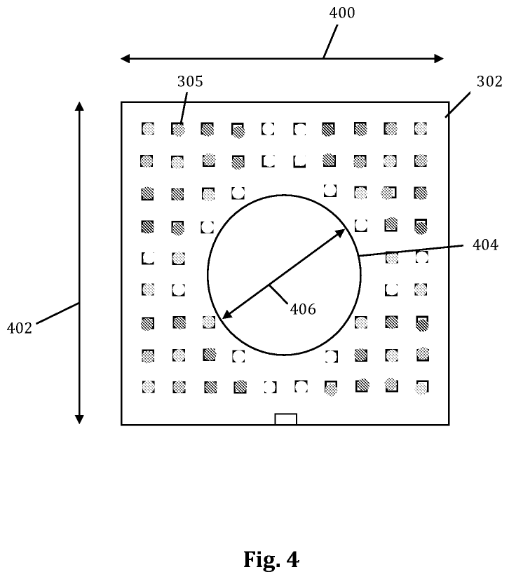

With reference now to FIG. 4, a schematic view of one embodiment of a layout of the first illumination feature 302, also referred to herein as the LED PCB 302 is shown. The LED PCB 302 can comprise a variety of shapes and sizes and can be made from a variety of materials. In some embodiments, the LED PCB 302 can comprise a rectangle defined by a length 400 and a width 402. In some embodiments, the length 400 can be between approximately 100 and 200 millimeters and/or between approximately 125 and 175 millimeters, the length 400 can be approximately 160 millimeters, and/or any other or intermediate value or range. In some embodiments, the width 402 can be between approximately 100 and 200 millimeters and/or between approximately 125 and 175 millimeters, the width can be approximately 150 millimeters, and/or any other or intermediate value or range.

In some embodiments, the LED PCB 302 can define an aperture 404 that can be, for example, a circular aperture. In some embodiments, the aperture 404 can be centrally located on the LED PCB 302 as is shown in FIG. 4. The aperture 406 shown in FIG. 4 can comprise a diameter of between 50 and 100 millimeters and/or a diameter of approximately 75 millimeters.

The LED PCB 302 can comprise a plurality of illumination elements 305. In some embodiments, this can include any desired of illumination elements 305 including, for example, approximately 10 illumination elements 305, approximately 20 illumination elements 305, approximately 50 illumination elements 305, approximately 66 illumination elements 305, approximately 75 illumination elements 305, approximately 100 illumination elements 305, and/or any other or intermediate number of illumination elements 305. In some embodiments, these illumination elements 305 can comprise RGB LEDs, 350 nm LEDs, 1800K LEDs, 3,000K LEDs, 5,000K LEDs, 6,500K LEDs, 8,000K LEDs, and/or 10,000K LEDs. In the specific embodiment depicted in FIG. 4, the LED PCB 302 comprises 16 RGB LEDs, 6 350 nm LEDs, 6 1800K LEDs, 8 3,000K LEDs, 10 5,000K LEDs, 6 6,500K LEDs, 8,000K LEDs, and/or 8 10,000K LEDs.

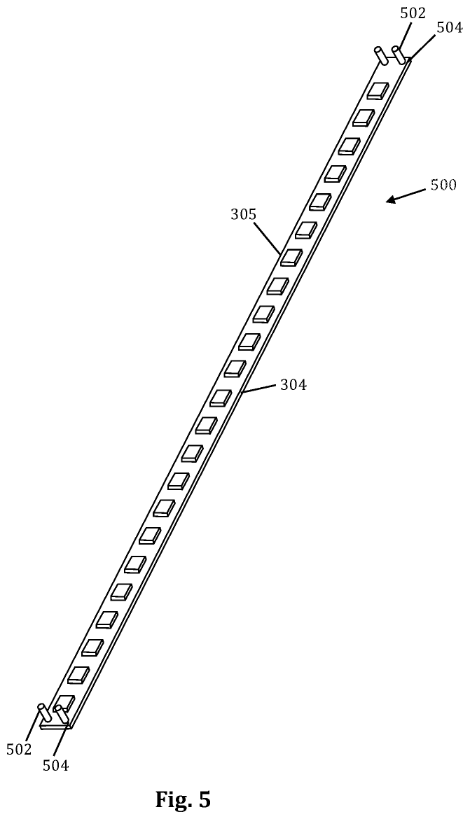

With reference now to FIG. 5, a perspective view of one embodiment of the second illumination feature 304 is shown. As seen in FIG. 5, the second illumination feature 304 can comprise an elongate member 500 that can comprise power connectors 502 at its ends 504. In some embodiments, one of these power connectors 502 can electrically connect the second illumination feature 304 to the LED PCB 302, and the other of these power connectors 502 can electrically connect the second illumination feature 304 to a portion of the greenhouse portion 104.

The second illumination feature 304 can comprise a plurality of illumination elements 305. In some embodiments, this plurality of illumination elements can comprise approximately 10 illumination elements 305, approximately 20 illumination elements 305, approximately 23 illumination elements 305, approximately 30 illumination elements 305, approximately 50 illumination elements 305, approximately 100 illumination elements 305, and/or any other or intermediate number of illumination elements 305. In some embodiments, the illumination elements 305 of the second illumination feature 304 can comprise alternating RGB LEDs and 6,500K LEDs.

In some embodiments, in which the first and second illumination features are controllably connected by the processor. The processor can selectively power some or all of the illumination elements 305 in the first and/or second illumination feature based on a detected size of a plant in the enclosed volume of the greenhouse portion.

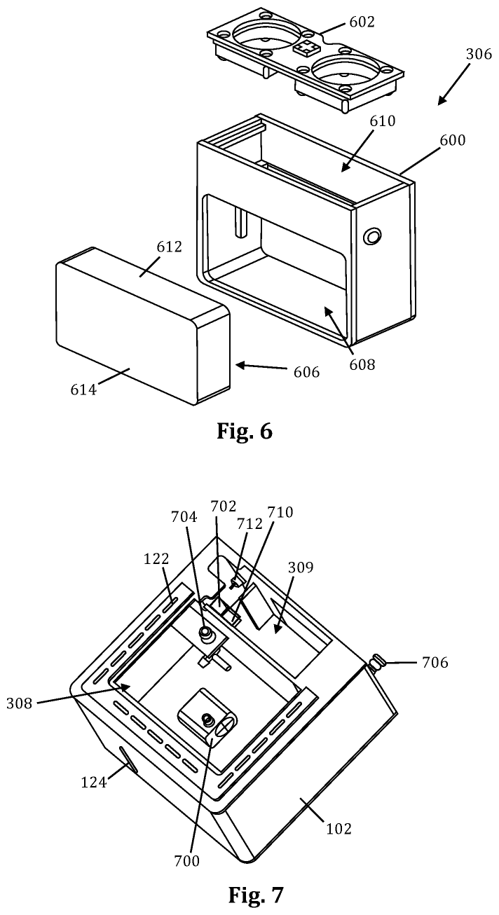

Returning again to FIG. 3, the system 100 can include a filtration member 306. In some embodiments, the filtration member 306 can obstruct one or both of the inlet aperture 126 and the outlet aperture 128 such that air flowing through the obstructed one or both of the inlet aperture 126 and the outlet aperture 128 passes through the filtration member 306. As seen in FIG. 3, the filtration member 306 can, in some embodiments, be received within a filter compartment 309 of the reservoir portion 102, and in some embodiments, the filtration member 306 can be a component of the greenhouse portion 104. The filtration member 306 is shown in greater detail in FIG. 6.

As seen in FIG. 6, the filtration member 306 can comprise a filter housing 600, one or several fans 602, and a filter member 606. The filter housing 600 can be sized and shaped to be received within the reservoir base 102 and can include an inlet 608 and an outlet 610. In some embodiments, when received within the reservoir base 102, the inlet 608 of the filter housing 600 can receive air from external to the greenhouse portion 104 and the outlet 610 of the filter housing 600 can be positioned adjacent to the inlet aperture 126 and can provide air to the inlet aperture 126.

The one or several fans 602 can comprise any component configured to move air through the greenhouse portion 104. In some embodiments, the one or several fans 602 can be electrically powered fans that can be controlled by the processor according to one or several parameters of the system 100 measured by one or several sensors associated with the system 100.

In some embodiments, the one or several fans 602 can be controlled by a processor 702 to control the velocity of air passing through the enclosed volume 116. In some embodiments, the processor 702 can control the one or several fans according to at least one of: a humidity level measured in the enclosed volume 116; a size of a plant in the enclosed volume 116; a weight of the plant in the enclosed volume 116; or a temperature level measured in the enclosed volume 116. In some embodiments, the velocity of the air can facilitate in the growth of a plant with a larger and/or thicker stem and/or in increasing the transport of nutrients to the leaves of the plant through the stem. In some embodiments, for example, the fans can be controlled to maintain a desired wind-speed, temperature, relative humidity, and/or the like through the greenhouse portion 104

The filter member 606 can comprise a first component 612 and a second component 614. In some embodiments, the first component 612 can comprise a first filter element that can be, for example, an activated carbon filter element. In some embodiments, the second components 612 can comprise a second filter element that can be, for example, a HEPA filter element. In some embodiments, the filter member 606 including the first and second components 612, 614 can be received and/or contained within the inlet of the filter housing 600.

Returning again to FIG. 3, the reservoir portion 102 can further include a reservoir 308. In some embodiments, the reservoir 308 can be configured to receive and hold a liquid such as, for example, water including water with fertilizer. In some embodiments, the water level indicator 124 can provide an indicator of the level of the water inside of the reservoir 308 of the reservoir portion 102

A perspective view of one embodiment of the reservoir portion 102 is shown in FIG. 7. As seen, the reservoir portion 102 includes the reservoir 308, the water level indicator 124, the filter compartment 309, plurality of apertures 122 extending through the top 106 of the reservoir portion 102 and into the reservoir 308, and a drain spout 704. The reservoir portion can further include a pump 700 that can be configured to pump water or other liquid from the reservoir 308 to the grow tray 118. In some embodiments, the rate of water or other liquid pumped by the pump can be controlled by the processor 702. In some embodiments, this processor 702 can be configured to receive data from one or more of the components of the system 100 and to provide control signals to one or more components of the system 100.

The processor 702 may be implemented as one or more integrated circuits (e.g., a conventional microprocessor or microcontroller). One or more processors, including single core and/or multicore processors, may be included in processing unit. The processing unit may be implemented as one or more independent processing units and/or with single or multicore processors and processor caches included in each processing unit. In other embodiments, processing unit may also be implemented as a quad-core processing unit or larger multicore designs (e.g., hexa-core processors, octo-core processors, ten-core processors, or greater).

The pump 700 can be fluidly connected to the grow tray 118 via a spout 704 and/or one or several hoses extending from the pump 700 to the spout 704 and/or from the spout 704 to the grow tray 118.

The reservoir portion 102 can further include the filter compartment 309 which can house the processor 702, a communications module 710, and a power module 712. In some embodiments, the processor 702 can be configured to control the operation of the system 100 according to computer code which can be, for example, stored in memory accessible by the processor 702. In some embodiments, the communications module 710 can be configured to send data to a user device and receive data from the user device. In some embodiments, the user can, via communication with the system 100 by the communications module 710, affect the operation of the system 100. The communications module 710 can be configured to communicate via a wired and/or wireless connection with the user device via one or several communications protocols or standards. The power module 712 can be configured to power the system 100 and can include, for example, one or several plugs, energy storage devices such as batteries, connectors, or the like.

In some embodiments, for example, the user can receive data from one or several sensors electrically connected with the processor 702. In some embodiments, this data can characterize, for example, an attribute of the enclosed volume 116 such as, for example, a temperature of the enclosed volume 116, a relative humidity of the enclosed volume 116, a hydration level in the grow tray 118, a wind velocity through the enclosed volume 116, a plant size and/or weight of the plant growing in the enclosed volume 116, illumination data characterizing the illumination of the plant growing in the enclosed volume 116, or the like. In some embodiments this data can characterize, for example, an attribute of the system 110 such as, for example, a water level in the reservoir 308, a turbidity of the water in the reservoir 308, a temperature of the water in the reservoir 308, a filter status, or the like.

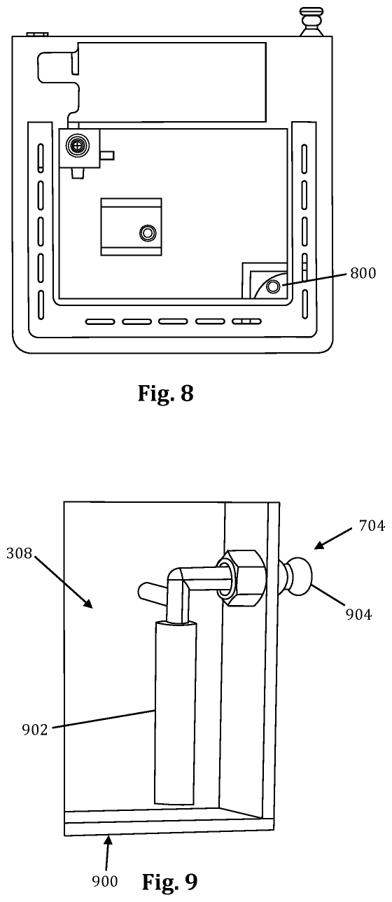

With reference now to FIG. 8, a top view of the reservoir portion 102 is shown. The reservoir portion 102 can further include a humidifying element 800 located in the reservoir 308, and specifically in the bottom of the reservoir 308. The humidifying element 800 can be configured to add water to the air in the enclosed volume 116 via the apertures 122. In some embodiments, the humidifying element 800 can comprise a mist or fog generator such as, for example, an ultrasonic droplet generator.

With reference now to FIG. 9, a side view of one embodiment of the drain spout 704 is shown. In some embodiments, the drain spout 704 can include a straw portion 902 extending towards the bottom 900 of the reservoir 308 and a spout portion 904 extending to outside of the reservoir portion 102. In some embodiments, the extending of the straw portion 902 towards the bottom 900 of the reservoir 308 can facilitate the removal of water relatively more proximate to the bottom 900 of the reservoir 308 before the removal of water relatively less proximate to the bottom 900 of the reservoir 308. In some embodiments, this can advantageously result in the removal of older water containing higher particulate levels and/or old fertilizer first. In some embodiments, the positioning of the drain spout 704 relative to the bottom 900 of the reservoir 308 can facilitate the siphoning of liquid out of the reservoir 308 until the liquid level is at the level of the outlet spout 904.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

While the principles of the disclosure have been described above in connection with specific apparatuses and methods, it is to be clearly understood that this description is made only by way of example and not as limitation on the scope of the disclosure.

What is claimed is:

1. A self-contained air filtration system, the system comprising:
a processor configured to receive data from one or several components of the system and to provide control signals to one or several components of the system;
a housing comprising:
a reservoir portion; and
a greenhouse portion connecting to the reservoir portion via a grow tray, wherein a top of the reservoir portion and the greenhouse portion define an enclosed volume, wherein the greenhouse portion comprises an inlet aperture and an outlet aperture, wherein the inlet aperture is obstructed by an inlet filter such that air flowing into the greenhouse portion passes through the inlet filter, and wherein the greenhouse portion is connected to a fan configured to propel air through the inlet aperture and out of the outlet aperture.

2. The system of claim 1, wherein the grow tray sits in the top of the reservoir portion at an angle such that water drains from one side of the grow tray to another side of the grow tray, wherein the grow tray comprises a sponge having a plurality of troughs arranged in a checkered pattern.

3. The system of claim 2, wherein the processor is configured to control the fan to affect the velocity of air passing through the enclosed volume according to at least one of:
a humidity level measured in the enclosed volume; a size of a plant in the enclosed volume; a weight of the plant in the enclosed volume; or a temperature level measured in the enclosed volume.

4. The system of claim 1, wherein the reservoir portion comprises a pump fluidly connected to the grow tray such that pump can deliver water to the grow tray, and wherein the reservoir portion comprises a humidifying element configured humidify the air in the greenhouse portion.

5. The system of claim 4, wherein the humidifying element comprises a droplet generator.

6. The system of claim 5, wherein the reservoir portion comprises a plurality of thru-holes extending from a reservoir in the reservoir portion to the enclosed volume of the greenhouse portion, wherein the reservoir is separated from the enclosed volume of the greenhouse portion by the grow tray, and wherein the plurality of thru-holes fluidly connect the reservoir to the enclosed volume of the greenhouse portion such that droplets generated by the droplet generator can enter the enclosed volume of the greenhouse portion.

7. The system of claim 4, wherein the reservoir portion comprises a drain and a water level sensor.

8. The system of claim 4, wherein the reservoir portion comprises a turbidity sensor configured to measure the turbidity of water stored in the reservoir portion of the housing.

9. The system of claim 4, wherein the greenhouse portion comprises a plurality of sensors.

10. The system of claim 9, wherein the plurality of sensors comprise at least one of: a light sensor; a humidity sensor; a moisture sensor; an oxygen sensor; a carbon dioxide sensor; or a plant size sensor.

11. The system of claim 9, wherein the plurality of sensors comprise: a light sensor, a humidity sensor positioned to measure the relative humidity of the air in the greenhouse portion; a moisture sensor positioned to measure a moisture level in the grow tray; and a plant size sensor.

12. The system of claim 11, wherein the plant size sensor comprises a scale.

13. The system of claim 11, wherein the plant size sensor comprises an optical detection system.

14. The system of claim 9, wherein the greenhouse portion comprises an outlet filter obstructing the outlet such that air flowing out of the greenhouse portion passes through the outlet filter.

15. The system of claim 14, wherein each of the inlet filter and the outlet filter comprise a first component and a second component.

16. The system of claim 15, wherein the first component comprises an activated carbon filter element.

17. The system of claim 16, wherein the second element comprises a HEPA filter element.

18. The system of claim 17, the greenhouse portion comprises a UV illuminator positioned to illuminate at least one of the first portion and the second portion of the outlet filter.

19. The system of claim 18, wherein the greenhouse portion comprises a plurality of walls extending between a top and a bottom of the greenhouse portion, wherein the distance between the top and the bottom of the greenhouse portion is at least one of: constant or variable; wherein the plurality of walls partially define the enclosed volume, and wherein the some or all of the plurality of walls are at least one of: transparent; opaque; or reflective.

20. The system of claim 19, wherein the processor is communicatingly connected to the plurality of sensors; wherein the greenhouse portion comprises a first illumination feature located at the top of the greenhouse portion and a second illumination feature extending at least partially between the top and the bottom of the greenhouse portion, wherein the second illumination feature comprises a plurality of illumination elements located at different positions between the top and the bottom of the greenhouse portion, wherein the first and second illumination features are controllably connected by the processor, and wherein the processor is configured to selectively power some or all of the illumination elements in the second illumination feature based on a detected size of a plant in the enclosed volume of the greenhouse portion.
